(19) United States
(12) Patent Application Publication
(10) Pub. No.: US 2012/0005036 A1
(43) Pub. Date: Jan. 5, 2012

(54) Loan-it-forward trade system and method

(76) Inventor: Ranel Einar Erickson, Henderson, NV (US)

(21) Appl. No.: 13/134,891

(22) Filed: Jun. 20, 2011

Related U.S. Application Data
(60) Provisional application No. 61/398,907, filed on Jul. 2, 2010.

(51) Int. Cl. G06Q 40/00; G06Q 30/00

(52) U.S. Cl. 705/26.2

(57) ABSTRACT

A system and method for creating purchase transactions based on a series of previously created loan transactions is provided. The system and method applies to small unorganized groups of neighbors as well as formal trade exchanges or bartering organizations. The system provides the means for subscribing members to create a network of members, called a loan group, by loaning or consigning products and services to a set of members some of whom in turn loan or consign products and services to a third set of members and this “loan-it-forward” process can repeat as many levels as desired creating a network structure. The method of this invention determines when a purchase transaction can occur and adjusts loan units along the paths in the network structure to provide payments (equal to the purchase transaction amount) on each loan along the paths of members connecting the two members involved in the purchase transaction.

### CROSS-REFERENCE TO RELATED APPLICATIONS

Provisional Application No. 61/398,907 with filing date Jul. 2, 2011

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates generally to the field of trade and more specifically to a system and method that stores and adjusts a series of members' loans or consignments to facilitate transactions in trade exchanges.

Trade exchanges (or bartering organizations) operate as commercial organizations who maintain record keeping systems in which each member has a trade account which is debited when purchases occur and credited when sales occur. Trade exchanges often help members leverage their unused capacities and excess inventories. The prior art contains various systems and methods to store, organize, and display information about members in the system and their products and services available or requested for trade. Trade exchanges use typical accounting systems and methods to maintain records of trade debits, credits, and account balances. The following prior art illustrates systems and methods associated with trade systems, most of which are cited because they at least mention loans or resolution of financial debt in the context of electronic exchanges.

Himmelstein discusses a method of bartering (trading) where a multiplicity of classes of products with allowable trade date ranges are compared to create trade transactions (Electronic bartering system, U.S. Pat. No. 7,680,726). This example illustrates the prior art's focus on systems and methods that organize groups of products or groups of participants in constructing a trade exchange transaction. Herschkorn discusses a system and method of trading loans in an electronic system where sellers offer loans and buyers submit bids and the system determines partial or full matches. (Bank loan trading system and method, U.S. Pat. No. 6,691,094) This prior art is an example of loans being used as products in trade exchanges. A similar approach where the exchange involves credit defaults is discussed by Jaffrey and Farooq's in their patent application. (System and method for facilitating exchange of credit default swaps, Patent Application No. 20100125518)

Chatterjee discusses a system and method of implementing electronic marketplaces that provide financial transaction services to members. This system uses member registration information to determine types of transactions available to participants and provides associated financial transaction services in connection with ongoing transactions involving the participants. (System and method for providing electronic financial transaction services, U.S. Pat. No. 7,698,240) But such financial transactions (even if loans) did not have a direct impact on the exchange of other goods and services in the electronic marketplace in this prior art.

As for validation, Saunders discusses a system and method for securing a recurrent billing transaction using a marked proxy code that includes a merchant system marker assigned to the merchant and a proxy code assigned to a consumer. The system uses these markers to validate a merchant's transaction request. (System and method for securing a recurrent billing transaction, U.S. Pat. No. 7,650,314) In particular, that this prior art does not use existing loan or other debt considerations to validate a transaction involving other products and services.

Postrel discusses a system and method for exchanging reward points previously stored in at least one user reward account stored on an associated reward server computer into a user reward exchange account associated with a trading server computer. In particular, this discussion involves the conversion of one type of unit, the user reward account units, to another, the server reward exchange account. (System for electronic barter, trading and redeeming points accumulated in frequent use reward programs, U.S. Pat. No. 7,624,041) In this prior art, it does discuss a second type of trade unit, but not associated with loan units nor do they create a structure for future trades in the exchange.

Trust is an important factor in trade exchanges. Moskowitz discusses a system for enhancing trust in transactions, most particularly in remote transactions between transactional parties such as online trade exchanges. Trust is enhanced through a variety of factors including subject matter of the transactions, the supplier of the goods and services, the appropriateness of a pricing structure, security of information exchange, data identification, authentication, and transmission. (Systems, methods and devices for trusted transactions, U.S. Pat. No. 7,159,116) Note in particular the absence of a factor for trusting a potential trade transaction that is related to prior loans existing between the members of the trade exchange.

As for binding, Walker discusses a method and apparatus for effectuating bilateral buyer-driven commerce. It allows prospective buyers of goods and services to communicate a binding purchase offer globally to potential sellers, for sellers conveniently to search for relevant buyer purchase offers, and for sellers potentially to bind a buyer to a contract based on the buyer's purchase offer. (Method and apparatus for a commercial network system designed to facilitate buyer-driven conditional purchase offers, U.S. Pat. No. 7,472,074) This prior art illustrates a need for systems and methods in exchanges to bind their members to complete certain transactions.

Concerning optimization, Iannacci discusses a system and process that provides an on-line, interactive, and fully integrated benefit-driven value exchange and settlement program that monitors, evaluates, and manages economic and personal benefits and executes functions to produce and acquire the maximum or preferred benefit items for users by guiding and automating appropriate payment and settlement actions. (System and method for an automated benefit recognition, acquisition, value exchange, and transaction settlement system using multivariable linear and nonlinear modeling, U.S. Pat. No. 7,318,049) Even though this invention does not relate directly to trade exchanges, it does provide an example of using patterns in data to maximize user value in settling financial transactions

The prior art does contain loans of trade units to members of an exchange. For example, “A credit line, offered by a growing number of barter exchanges, is basically an extension of barter credits, which allow a business to buy essential items from other network members before selling its own goods into the system. “One of our customers owns a roofing business, which means he can perform his work only during the warm months,” says Dagenais. “But he uses our credit line first during the winter to fix his trucks and get his advertising campaign ready.” . . . If you apply, expect barter companies to check your Dun & Bradstreet credit rating and vendor references, although the application and approval process should be easier than with a bank loan; on credit lines worth more than $10,000, owners may also have to sign personal guarantees. Although you'll pay interest on purchases you make with your credit line, you'll be able to pay back interest and principal with bartered goods rather than precious cash” (http://www.inc.com/magazine/19941001/3159.html, downloaded 2010-06-21) Such loans (credit lines), though, originate from the trade exchanges (barter companies) themselves and this practice must be done sparingly so as not to inflate the value of the trade unit.

We use the term “loan-it-forward” instead of “pay-it-forward”, to emphasize the expectation of having a loan between members of an exchange paid back with interest. We also anticipate the opportunity for members to donate interest to charitable organizations. In the prior art, the pay-it-forward concept is found in a variety of contexts. For example, pay-it-forward is found in multi-level schemes where participants pay some money and recruit others who pay money back, etc. (see for example http://stastup.biz/profiles/blogs/2084667:BlogPost:377131, downloaded 2010-06-21). Multi-level schemes is not the context nor the intention of our invention.

Loan-it-forward concepts have been used in the prior art to market products and services by passing the same item forward after using it. For example, consider the marketing of Veronica Mars First Season DVDs wherein they “are asking you to try watching three or four episodes to see if you like it and decide if you want to watch the rest of the season,” explained Mark Thompson from Neptune Rising. “After you are done with the set, we are asking you to loan it forward to somebody else and give them an opportunity to see if they might like our show.” (http://www.richardrbecker.com/2008/03/demonstrating-high-touch-veronica-mars.html#uds-search-results, downloaded 2010-06-21)

Prior art also contains loan-it-forward systems and methods for providing education, even at the international level. For example, the Center for Human Development (a Hindu charity) describes their pay-it-forward program as follows, “Through this model, financial help would be provided to deserving students in the form of a loan. The scheme professes to be different from other loan options available for the students today as it will ultimately be funded by the payback of the original beneficiaries.” http://www.hindu.com/thehindu/edu/2009/11/09/stories/2009110950460800.htm The payback comes from the future productivity of the students in their careers.

As the above referenced prior art indicates, even though trade exchanges themselves can provide loans to selected members, there is a need for systems and methods that allow members to loan or consign products and services to other members at any time or any amount. There is a need to validate relationships and increase trust in the value of trade transactions and to more accountably reward those who give quality products and services to each other in the system. Trade exchanges often fail if their members do not bind themselves to accepting trade units for products and services, and this is often the result of inflated trade unit values between parties that have little or no prior relationships. Trade exchanges also have a need to allow their members to give loans to other members of other trade exchanges.

### BRIEF SUMMARY OF THE INVENTION

The foregoing problems found in the prior art have been successfully overcome by the present invention, which is directed to a system and method that allows members of trade exchanges to use loan units (in addition to trade units) to record individual loans or consignments between members of the trade exchange. The system allows members to freely create loans and consignments to other members. This process can repeat any number of times thereby creating a network of loan unit relationships. When a member requests a product and service from another member in their loan-it-forward down line a trade transaction occurs, and the invention dynamically adjusts the network path (a chain of participants' loans) to accommodate a trade. Significant trust occurs in this new invention because the two new trading partners are linked together by a path of trusted loan relationships. Each link in this path consists of a loan from one member to another based on a pre-existing trusted loan.

In the preferred embodiment, this invention is an online computer system that stores information in a database describing collections (or networks) of subscribing members who have provided loans to each other and recorded such loans using a loan unit and that provides the means be which the subscribing members can create trade transactions based on network structures of these loan units. These subscribing members can consist of small informal groups of neighbors or members of formal trade exchanges (bartering organizations). The loan unit is not a trade unit as understood in prior art but can coexist with trade unit as used by trade exchanges. A member creates such a network of members, called a loan group, by loaning or consigning products and services to a set of members some of whom in turn loan or consign products and services to a third set of members and this “loan-it-forward” process can repeat as many levels as desired creating a network structure.

When a purchase transaction occurs, the method of this invention adjusts the loan units along the path in the network structure so as to provide payments (equal to the trade transaction amount) on each loan along paths of members connecting the two members involved in the purchase transaction. This novel concept has significant value in trade exchanges because this system allows members to pay other members' debts even when they are not direct participants in the current purchase transaction. This also significantly increases trust because the value of such loan transactions has already been set by the individual pairs of members. One embodiment of this invention involves a trade exchange who licenses and integrates into their existing trade-exchange applications the systems and methods of this invention. Another embodiment of this invention involves an international organization that extends to multiple trade exchanges the opportunity for their members to subscribe to the loan-it-forward system and conduct business using this novel method with other subscribing members. This creates secure and trusted opportunities to loan-it-forward and then later purchase products and services based on the loan units structures.

### BRIEF DESCRIPTION OF THE SEVERAL VIEWS OF THE DRAWINGS

In order that the manner in which the above recited advantages and objects of the invention are obtained, a more particular description of the invention will be rendered by reference to specific embodiments thereof that are illustrated in the appended drawing. Understanding that this drawing depicts only typical embodiments of the invention and is not to be considered to be limiting of its scope, the invention will be described and explained with additional specificity and detail through the use of the accompanying drawings in which:

FIG. 1 is a system architecture diagram illustrating the system for a preferred embodiment including a multiplicity of trade exchanges whose members subscribe to a centralized loan application.

FIG. 2 is an architectural diagram describing an example of the loan group data structures found in FIG. 1 in further detail using network flow terminology.

FIG. 3 is one implementation of creating loans between members who subscribe to the loan-it-forward application.

FIG. 4 is one implementation of the method of creating a trade transaction based on loan paths in the loan group data structure.

### DETAILED DESCRIPTION OF THE INVENTION

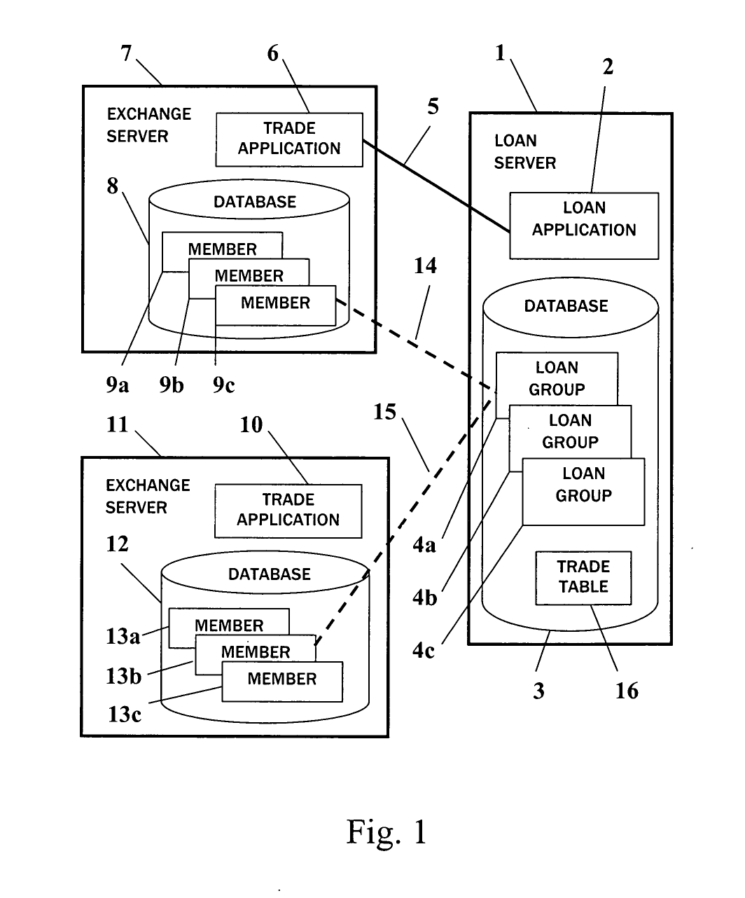

The following invention is described by using a specific example of the system where two separate trade exchange companies integrate their trade applications with a centralized loan application hosted on a server of a third company and where a subset of the members of each trade exchange company has opted to participate in loan groups each of which have associated database records that record the loans between the participants in each group. Using FIGS. 1-4 and the specific example in this manner to present the invention should not be construed as limiting of its scope. The present invention contemplates systems that use any combination of trade exchanges, loan groups and subscribing members. For example, one trade exchange may license the loan-it-forward trade system and method to integrate it into their own trade application and not commingle there members with other trade exchanges.

Embodiments of the present invention may comprise a general-purpose computer with any number of basic configurations including a secure mainframe within one company and its subsidiaries, even though the preferred embodiment presented here uses the configuration of industry-standard servers on the Internet. An apparatus implementing the methods of the present invention can also comprise a special purpose computer, hand-held device or other hardware systems and all should be included within its scope. Communications links typically will comprise an Internet connection but anticipates any electronic communication link used to transmit data including private networks and wireless connections.

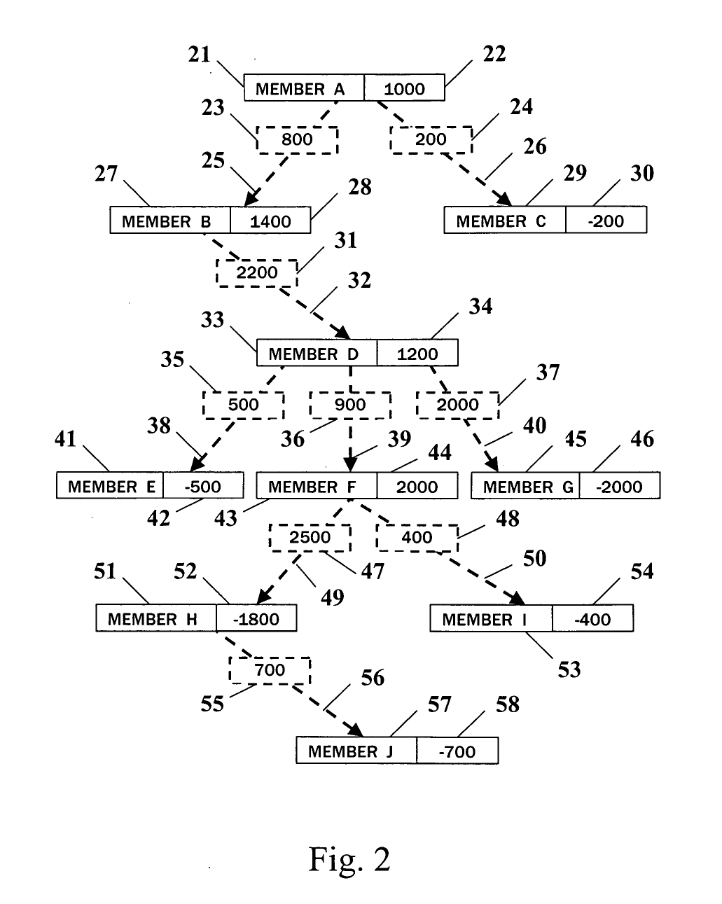

More specifically, FIG. 1 illustrates the system architecture of a general-purpose computer system that contains a computer server 1 that hosts a loan application 2 that stores and retrieves data from a database 3. Database 3 contains a trade table 16 and a multiplicity of loan group data structures 4a, 4b, and 4c that are described in more detail in FIG. 2. Loan application 2 communicates through an Internet connection 5 with the trade application 6 residing on computer server 7 of a trade exchange company. The trade application 6 stores and retrieves data from a relational database 8 that contains a multiplicity of member data records 9a, 9b, and 9c.

The system allows for a multiplicity of trade applications connected to loan application 2. FIG. 1 illustrates this using a second trade application 10 residing on a computer server 11 of another trade exchange company. The trade application 10 stores and retrieves data from a relational database 12 that contains a multiplicity of member data records 13a, 13b, and 13c. And similar to the first trade application 6, this second trade application 10 communicates to the loan application 2 via the Internet.

The loan application 2, which plays the central role of this embodiment of the system, provides standard computer instructions via a web page to all subscribers currently using the trade application 6 to transfer or enter membership information from the member data records 9a, 9b, and 9c into the loan group data structures 4a, 4b, and 4c in order to record loan transactions. For example, if the member associated with the member data record 9c in the first trade exchange loans his or her services or consigns products to the member associated with the member data record 13b in the second trade exchange, then abstract links 14 and 15 represent the transfer of identification data from member data records 9c and 13b, respectively, into loan group data structure 4a.

FIG. 2 uses a particular example to illustrate the architecture of a loan group data structure such as 4a. Using an industry-standard directed-arc network-flow structure, a loan group data structure consists of a set of nodes 21,27,29,33,41,43,45,51,53,57 with their corresponding loan balances 22,28,30,34,42,44,46,52,54,58 connected by a set of directed arcs 25,26,32,38,39,40,49,50,56 with their corresponding loan amounts 23,24,31,35,36,37,47,48,55. Using industry-standard techniques, this directed-arc network-flow structure can be stored in database 3 as an XML string or relational tables that can include additional information associated with the trade exchange member that each node represents. Note in particular that the conservation of flow principle inherent in network flow models applies to each node, namely, the sum of the loan amounts over all incoming arcs plus the loan balance equals the sum of the loan amounts over all outgoing arcs. For example, consider node 33. The sum of loan amounts 31 of 2200 over all incoming arcs 32 into node 33 plus the loan balance 34 of 1200 equals the sum of the loan amounts 35, 36, and 37 of 500, 900, and 2000 respectfully: 2200+1200=2400=500+900+2000.

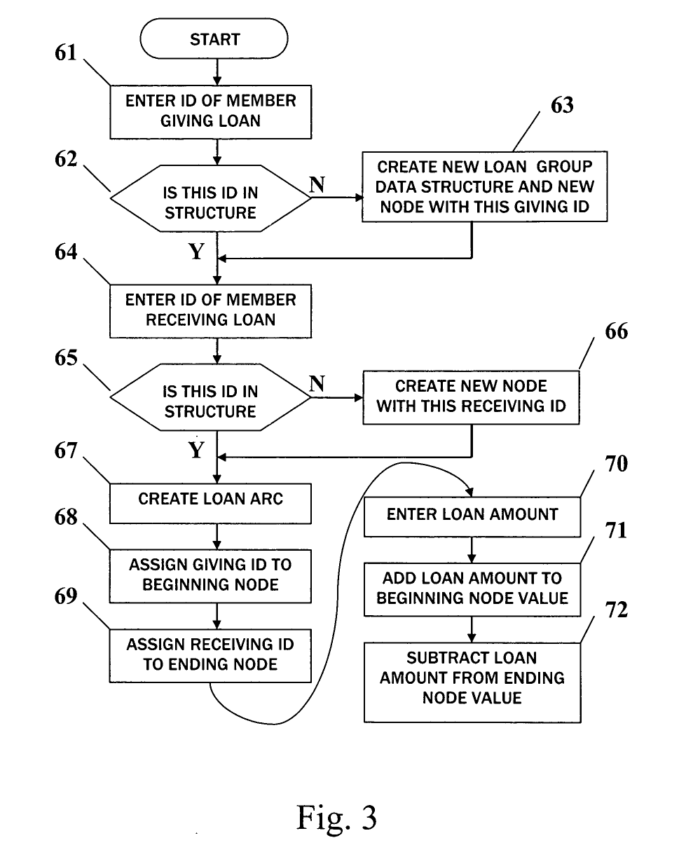

FIG. 3 uses a flow diagram to illustrate one implementation of a method to create a loan transaction. Assume for this discussion that we are creating the loan transaction represented by the directed arc 56 at the bottom of the loan group data structure in FIG. 2, so member H (node 51) will give a loan or consignment to a new member J (node 57) in the loan amount 55 of 700 dollars. Before the loan, the loan balance 52 of node 51 was −2500 corresponding to the loan amount 47 on directed arc 49. The loan transaction creation process starts in step 61 wherein a user enters into loan application 2 of FIG. 1 the member ID of the member (node 51) who is giving the loan. The execution proceeds to a decision block 62 where the loan application 2 determines if this giving member ID already exists in one of the multiplicity of loan groups 4a,4b, 4c. If the giving member ID does not exists, then step 63 creates a new loan group data structure in database 3 and creates the first node 21 in a new loan group data structure that is then used to continue to step 64; otherwise execution continues with step 64. In this example, the loan application 2 finds that member H exists as node 51 in the loan group data structure represented by FIG. 2.

At step 64, a user enters into loan application 2 the member ID of the member (node 57) who is receiving the loan. The execution proceeds to a decision block 65 where the loan application 2 determines if this receiving member ID already exists in the given loan structure. If not, step 66 creates a new node (node 57) in the loan group data structure of FIG. 2 using this receiving member ID and then continues to step 67. Execution continues with step 67 where the loan application 2 creates a new directed arc 56. Execution continues sequentially through step 68 where the ID of the giving node 51 is assigned as the beginning node 51 of directed arc 56 and then step 69 where the ID of the receiving node 57 is assigned as the ending node 57 of directed arc 56. After the user enters the loan amount 55 equal to $700 in step 70, step 71 adds the loan amount 55 of $700 to the loan balance 52 of node 51 resulting in (−2500+700=−1800). Step 72 finishes the loan creation process by subtracting the loan amount 55 equal to $700 from the loan balance 58 (which is initially set to 0) of node 57 resulting in (0−700=−700).

The preferred embodiment encourages trade exchanges to use these loan balances 22,28,30,34,42,44,46,52,54,58 as their trade account balances thereby replacing the role of traditional trade units. In such an implementation, the creation of trade units in the trade exchange only occurs when value is realized by chains of such member-to-member loans. If an exchange cannot replace their existing trade units with trade units derived by the system and method of this invention, then they can still implement the invention by creating a new class of (stable and trusted) trade units called, for example, loan units.

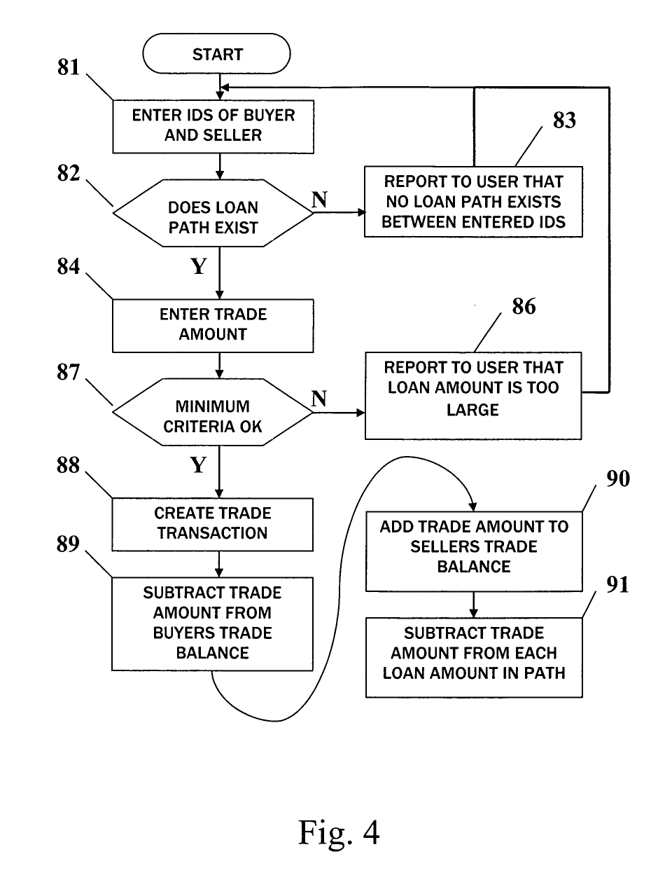

FIG. 4 uses a flow diagram to illustrate one implementation of a method to create a trade transaction. As an example to facilitate this discussion assume that member B associated with node 27 in FIG. 2 desires to create a trade transaction valued at the amount of $500 to purchase products and services from member H associated with node 51. The method starts with step 81 where a user enters in a member ID “B” for the buyer associated with node 27 and a member ID “H” for the seller associated with node 51. Step 82 then determines if a path exists from node 27 to node 51 through a directed-arc network flow structure using industry-standard network structure algorithms. If no such path exists, then step 83 informs the user and returns them back to input step 81. If a path exists, then the user enters in the trade purchase amount in step 84 which in our example is worth $500.

The execution continues to step 87 where the system finds the minimum loan amount over all loan amounts 31, 36, 47 in the path which in this example being 2200, 900, 2500. So the minimum is 900. Since the trade purchase amount is $500 and the minimum of the loan amounts is 900, the loan application 2 of FIG. 1 would allow this trade to occur. If the propose trade amount had been larger than the minimum loan amounts along the path, step 86 would inform the user that the amount is to large to complete the transaction and return the user to the input step 81 to start over (or another embodiment can return it to step 84 to reenter the amount). If the enter trade amount satisfies this minimum criteria, execution continues with step 88 where the loan application 2 of FIG. 1 will create a trade record in the trade table 16. Execution then continues to step 89 where the trade amount ($500) entered in step 84 is subtracted from the buyer's trade balance 28 resulting in our example of 1400−500=900. Step 90 adds the trade amount ($500) to the seller's trade balance 52 resulting in our example of −1800+500=−1300. And then to complete the trade transaction, step 91 subtracts the trade amount ($500) from each of the loan amounts 31, 36, and 47 resulting in our example of the new loan amounts of 2200−500=1700, 900−500=400, and 2500−500=2000, respectfully.

The preferred embodiment allows for the trade exchange to collect an interest payment when the trade transaction occurs and the maximum amount of the potential trade would be further limited by this additional amount. So in this example, if the interest is 10% on the trade transaction of $500, then $550 would be compared to the minimum loan value of $900 and $50 would be debited from the loan amount 52 of −1800 resulting in −1850 and $50 credited to the trade exchange loan account.

The preferred embodiment also allows for the seller to pay an interest or gratitude payment directly to the buyer after the trade transaction occurs and that such interest or gratitude payment may be donated by the buyer to charitable organizations.

The preferred embodiment also anticipates the use of industry standard network flow algorithms to handle the occurrence of multiple loan paths from a buyer to a seller. Such algorithms can be used to calculate and display to the user the maximum trade allowable for each other subscribing member.

Essentially, all the loans along such paths are partially paid back by this novel criterion for determining whether or not a trade can occur. This method results in significant benefits for trade exchanges. It essentially requires that a participant first give a substantial amount to the other participants and encourage them to repeat this loaning process before they can purchase products and services from participants in their own “loan-it-forward” down-line network. Hence the invention restricts members to take only from those members who owe loan units to them vicariously through chains of outstanding loans. This creates a stable type of trade unit called a loan unit for the trade exchange, increased trust among trading partners, and a binding relationship through repayment of loans for multiple members when a trade transaction occurs.

We claim:

1. A system for providing users with the means by which they can use loan units to record loans to other users (including consignments of products and provided services) and conditions when a user can use loan units to purchase products and services from another user, the system comprising
a primary computer server with an associated storage device and software program to store information about each user and to store loan transaction data that includes the lender's identification information, the borrower's identification information, and the value of the loan as recorded as loan units;
means for determining whether or not a loan-unit purchase transaction can occur (where a buyer purchases products or services from a seller using loan units) based on the condition that the value of the transaction is less than or equal to the minimum loan unit amount on a plurality of sequential loans starting with the buyer as the lender in the first loan and where the borrower in the first loan is the lender in the second loan, the borrower in the second loan is the lender in the third loan, the borrower in the n-th loan is the lender in the (n+1) th loan, and continuing until the borrower of the last loan is the seller.

2. The system of claim 1, wherein the loan value of each sequential loan is reduced by the value of the purchase transaction when such loan unit purchase transaction occurs.

3. The system of claim 2, wherein the seller will pay interest to the buyer on the value of the purchase transaction based on an interest rate determined by mutual agreements that govern the original loan transactions.

4. The system of claim 3, wherein the buyer donates the interest on loans settled at the time of a purchase transaction to charitable organizations.

5. A method of processing a loan-unit purchase transaction between a buyer and a seller who both belong to a group of lenders and borrowers comprising the steps of
maintaining records in a computer system of a plurality of loans where each loan is represented as a directed arc between the lender and borrower of the loan;
determining a directed path where the buyer is the lender in the first loan arc, the borrower in the first loan arc is the lender in the second loan arc, the borrower in the second loan arc is the lender in the third loan arc, the borrower in the n-th loan arc is the lender in the (n+1) st loan arc, continuing until the borrower of the last loan arc is the seller;
allowing the lender of the first loan arc (the buyer) in the directed path to purchase products and services from the borrower of the last loan arc (the seller) in the directed path up to a purchase value that is less than or equal to the minimum loan value over all the loan arcs in the directed path of loan arcs; and
reducing the loan values on each loan arc in the directed path by subtracting the purchase value from each of the loan arc values.

6. The method of claim 5, where the maximum amount of a (loan-unit) purchase transaction allowed for a each seller is obtained and displayed to a potential buyer by the additional steps of
organizing the loan records in the database into a directed-arc network-flow structure containing nodes for each member of the group and a directed arc for each loan from a lender node to a borrower node;
determining the maximum flow using standard mathematical algorithms from the buyer node to each seller node in the directed network of loan arcs where the arc capacities are the loan values; and
displaying on a computer screen to the buyer a list of sellers with each seller's corresponding maximum flow values as the maximum amount that the buyer can purchase from the seller using loan units.
